(19) United States
(12) Patent Application Publication
(10) Pub. No.: US 2021/0255238 A1
(43) Pub. Date: Aug. 19, 2021

(54) CONCEPT OF A COUPLED ELECTROTHERMAL SIMULATION

(71) Applicant: Fraunhofer-Gesellschaft zur Foerderung der angewandten Forschung e.V., Munich (DE)

(72) Inventor: Christoph SOHRMANN, Dresden (DE)

(21) Appl. No.: 17/174,248

(22) Filed: Feb. 11, 2021

(30) Foreign Application Priority Data
Feb. 13, 2020 (EP) 20157275.7

(51) Int. Cl. G01R 31/28; G06F 30/39

(52) U.S. Cl. CPC G01R 31/2874; G06F 2119/08; G06F 30/39

(57) ABSTRACT

The present invention relates to an apparatus for generating a thermal equivalent circuit of a physical structure, wherein the apparatus is configured to determine thermal admittance matrices based on a modelling of a physical structure for a plurality of frequencies; and wherein the apparatus is configured to determine a thermal equivalent circuit based on the thermal admittance matrices for the plurality of frequencies.

### CROSS-REFERENCE TO RELATED APPLICATIONS

This application claims priority from European Patent Application No. 20157275.7, which was filed on Feb. 13, 2020, and is incorporated herein in its entirety by reference.

Embodiments according to the invention relate to a concept for generating a thermal equivalent circuit, a computer for determining such a thermal equivalent circuit as well as a respective system and method.

### BACKGROUND OF THE INVENTION

The behavior of many technical systems can be described by equivalent circuits. It is a prerequisite that a mathematical equivalent exists between the problem to be examined and an electrical network. Such an equivalent circuit is frequently more intuitive and can be analyzed, for example, with a comparatively simple circuit simulator.

Particularly from the electronic design, for example, thermal equivalent circuits are used, which model the flow of the heat flow between the devices in an electronic circuit. Here, the voltages in such a thermal equivalent circuit correspond to the temperatures resulting in the devices.

In modern electronic circuits, thermal effects have a significant impact on their electrical behavior. It is mainly due to the increasing complexity of integrated circuits and the ongoing tendency to constantly rising integration densities and clock frequencies but also the usage of electronics in technical systems under the most diverse environmental conditions, that considering thermal electrical interactions is already needed in the circuit design.

Thermal electrical interactions in electronic circuits result from the temperature dependency of electrical parameters of the circuit elements.

The already mentioned increased integration densities in electronic circuits and the usage of electronics under extreme environmental conditions increasingly involve the consideration of thermal electrical interactions. Additionally, significantly increased clock frequencies also influence the respective electronic circuits, wherein thermal effects on such a chip increasingly have an impact on the function of the circuit. Therefore, methods in circuit design that do not consider the thermal effects in the chip, for example based on thermal equivalent circuits, are no longer useful.

The generation of thermal equivalent circuits for the electronic design has been described multiple times in the literature, such as in references [1-5]. Here, starting from a heat conduction equation and spatial discretization of the technically realized circuit, the problem is formulated as a matrix equation system. An equivalent circuit having an equivalent behavior is constructed from the same by means of a suitable method. However, it is a disadvantage that such equivalent circuits become so large that despite the currently available high computing resources the same cannot be solved for practically relevant problematic quantities or only with very large time effort. Therefore, the same are not suitable for the usage in the time-critical electronic design. This applies also to references [6] and [7].

For solving the problem of equivalent circuits that are too large, mathematical methods of model order reduction (MOR) have been suggested, such as in references [8-10]. Here, the size of the matrix equation system is reduced without significantly changing the behavior of the equivalent circuit.

Significant disadvantages of these methods are that:
model order reduction methods have to be parametrized by an experienced user;
most MOR methods only work for linear problems; and
knowledge of the underlying equation system (system matrices) is needed.

Due to the described disadvantages of existing approaches, no commercial implementations exist so far. Thus, coupled electrothermal simulation has so far not been used in industrial practice.

Therefore, it is desirable to obtain a concept preventing the above stated disadvantages. The basic idea of the solution is to consider the thermal problem in the frequency domain instead of in the time domain as in previous applications. Thereby, a plurality of established methods from the field of linear network theory, i.e., electrical engineering, can be transferred to the thermal problem and can be used for solving the problem.

According to the invention, a thermal equivalent circuit is to analyze electrothermal interactions in a design stage, wherein thermally induced errors can already be prevented in this phase. Thus, for example, thermal runaway of the circuit can be prevented.

Thermal runaway relates to overheating of a physical structure of a technical apparatus due to a self-reinforcing heat producing process. Thermal runaway can frequently result in a fire or an explosion and hence causes destruction of the apparatus, e.g., by overpressure.

For performing electrothermal analysis, a method for generating the thermal equivalent circuit is needed.

### SUMMARY

An embodiment may have an apparatus for generating a thermal equivalent circuit of a physical structure, wherein the apparatus is configured to determine thermal admittance matrices based on a modelling of a physical structure for a plurality of frequencies; and wherein the apparatus is configured to determine a thermal equivalent circuit based on the thermal admittance matrices for the plurality of frequencies.

According to another embodiment, an apparatus for thermal simulation of a physical structure may have an inventive apparatus for generating a thermal equivalent circuit and the apparatus is configured to determine a thermal response of the physical structure based on the thermal equivalent circuit and information on a thermal excitation of the physical structure.

Another embodiment may have a method for generating a thermal equivalent circuit of a physical structure, wherein the method determines thermal admittance matrices based on a modelling of a physical structure for a plurality of frequencies; and determines a thermal equivalent circuit based on the thermal admittance matrices for the plurality of frequencies.

According to another embodiment, a method for thermal simulation of a physical structure, may have an inventive method for generating a thermal equivalent and wherein a thermal response of the physical structure is determined by the method for thermal simulation based on the thermal equivalent circuit and information on thermal excitation of the physical structure.

Another embodiment may have a non-transitory digital storage medium having a computer program stored thereon to perform any of the inventive methods when said computer program is run by a computer.

An embodiment according to this invention relates to an apparatus for generating a thermal equivalent circuit of a physical structure, wherein the apparatus is configured to determine thermal admittance matrices describing a connection between temperatures at a plurality of thermal ports, i.e., thermal inputs and outputs via which heat can flow in or off and resulting heat flows, based on a modeling of a physical structure, for example a circuit with electrical or electronic members, for a plurality of frequencies of a thermal excitation, for example by using a thermal simulation program; and wherein the apparatus is configured to determine a linear thermal equivalent circuit based on the thermal admittance matrices for the plurality of frequencies.

By means of the equivalent circuit, the temperatures of the devices of an electrical circuit can be determined by a simple circuit simulation. An advantage of this embodiment is the prevention of complicated time-consuming methods for solving a partial differential equation/heat conduction equation, wherein efficient consideration of electrothermal interaction effects between heat generation and heat propagation is enabled.

One embodiment according to this invention relates to an apparatus for thermal simulation of a physical structure, wherein the apparatus for thermal simulation comprises an apparatus for generating a thermal equivalent circuit and wherein the apparatus is configured to determine a thermal response of the physical structure based on the thermal equivalent circuit and information on a thermal excitation, e.g., an amount of heat applied to or flowing off from different ports of the physical structure, e.g., temperatures at different ports of the physical structure.

According to this embodiment, the temperature is determined within the physical structure of the electrical circuit by direct thermal excitation at the devices, wherein, advantageously, faster model generation is enabled by limiting the excitation to the relevant thermal ports.

According to an embodiment, the apparatus for thermal simulation is configured to simulate an electrical circuit that is part of the physical structure or the circuit elements of which are thermally interacting with the physical structure.

As a technical effect of this embodiment, temperature propagation within the entire physical structure is simulated. It is advantageous that the entire physical structure is mapped in the thermal equivalent circuit model and is considered in its simulation.

According to an embodiment, the apparatus for thermal simulation is configured to determine the thermal excitation in dependence on a simulation of the electrical circuit and/or to consider the thermal response of the physical structures when simulating the electrical circuit.

Here, both the electrical as well as the thermal behavior of the circuit can be determined simultaneously. It is advantageous that the temperatures that result during operation of the circuit due to an interaction between electrical and thermal behavior can be determined.

According to an embodiment, the apparatus for thermal simulation comprises a plurality of electrical elements. Here, interaction between different elements of the circuit is considered in the thermal equivalent circuit. Here, it is possible to correctly predict mutual heating of devices by the model, wherein underestimating the temperature can be prevented.

An embodiment according to this invention relates to a method for generating a thermal equivalent circuit of a physical structure, wherein the method determines thermal admittance matrices based on a modeling of a physical structure for a plurality of frequencies, and determines a thermal equivalent circuit based on the thermal admittance matrices for the plurality of frequencies.

Here, the temperatures of the devices of an electrical circuit can also be determined by a simple circuit simulation. An advantage of this method is the prevention of complicated time-consuming methods for solving a partial differential equation/heat conduction equation, wherein efficient consideration of electrothermal interaction effects between heat generation and heat propagation is enabled.

One embodiment according to this invention relates to a method for thermal simulation of a physical structure comprising a method for generating a thermal equivalent circuit, wherein a thermal response of the physical structure is determined by the method for thermal simulation based on the thermal equivalent circuit and information on thermal excitation of the physical structure.

Here, determining the temperature takes place within the physical structure of the electrical circuit by direct thermal excitation at the devices, wherein, advantageously, faster model generation is enabled by limiting the excitation to the relevant thermal ports.

According to an embodiment, the method for thermal simulation simulates an electrical circuit that is part of the physical structure.

According to this embodiment, temperature propagation within the entire physical structure is simulated. It is advantageous that the entire physical structure is mapped in the thermal equivalent circuit model and is considered during its simulation.

According to an embodiment, the method for thermal simulation determines the thermal excitation depending on the simulation of the electrical circuit and/or considers the thermal response of the physical structure when simulating the electrical circuit.

Both the electrical as well as the thermal behavior of the circuits can be determined simultaneously. It is advantageous that the temperatures can be determined that result during operation of the circuit due to interaction between electrical and thermal behavior.

According to an embodiment, the method for thermal simulation comprises modeling a physical structure in a thermal simulation program, a selection of inputs and outputs as ports of a thermal equivalent network to be generated with the thermal simulation program to determine a thermal admittance matrix by using the thermal simulation program for different frequencies.

In this embodiment, the method decouples the analysis of the physical structure and the generation of the thermal network list. Thereby, advantageously, a higher degree of automation becomes possible by using specialized algorithms for the individual method steps. Thereby, methods that are difficult to be automated, such as model order reduction (MOR), can be avoided.

According to a further embodiment, in the method for thermal simulation, a linear thermal equivalent circuit is generated from the admittance matrix. Thereby, it is possible to simulate an equivalent circuit with a simple circuit simulation wherein usage of special solvers for complex matrices can be prevented.

According to an embodiment, in the method for thermal simulation, non-zero elements of the admittance matrix are reduced by using linear dependencies within the admittance matrix.

As a technical effect, a reduction of the number of connections between the devices of the resulting thermal equivalent circuit is possible, wherein fewer connections generate a more compact equivalent circuit that can be simulated in a shorter time.

According to an embodiment, in the method for thermal simulation, an admittance matrix is approximated with rational functions whose frequency dependent elements are obtained from previous calculations.

As a technical effect, a matrix equation having the frequency as explicit parameters is obtained from the amount of admittance matrixes (one per frequency as in the above calculations). Here, it is advantageous to generate the thermal network list from the explicit frequency dependency by means of system identification.

According to an embodiment of the method for thermal simulation, all matrix elements of the admittance matrix are provided simultaneously with an identical set of stable poles according to a vector matching principle, wherein the admittance matrices obtained by simulations are explicitly represented. Advantageously, a common set of poles allows the representation of the admittance matrices as matrix equation with the frequency as explicit parameter.

According to an embodiment of the method for thermal simulation, a temperature oscillating with the frequency f is provided at a port, a constant temperature is provided at all other ports, resulting (normalized) heat flows result in a column of the thermal admittance matrix Y(f) at all ports and a determination of all columns of Y(f) takes place by repeated execution for remaining ports.

Thus, as a technical effect, thermal simulation and generation of the admittance matrices are decoupled. Advantageously, such a method can be performed with any black box method, wherein the knowledge of internal equation systems needed in other methods can be avoided.

### BRIEF DESCRIPTION OF THE DRAWINGS

Embodiments of the present invention will be detailed subsequently referring to the appended drawings, in which:

FIG. 1 shows a schematic illustration of an inventive method for generating a thermal equivalent circuit of a physical structure; and

FIG. 2 shows a schematic illustration of a partial area of the physical structure of FIG. 1.

### DETAILED DESCRIPTION OF THE INVENTION

In the following description, equal or similar elements or elements having the same or similar functionality are indicated by the same or similar reference digits even when they occur in different reference numbers.

In the following description, a plurality of details are presented to allow a more extensive explanation of the embodiments of the present invention. However, it is obvious to a person skilled in the art that embodiments of the present invention can be performed without these specific details. In other cases, known structures and apparatuses are not illustrated in detail but in block diagrams to prevent that the embodiments of the present invention are obstructed. Above that, features of the different embodiments described herein can be combined as long as it is not explicitly stated otherwise.

As already mentioned, the invention is based on a method avoiding the above stated disadvantages. The basic idea of the solution is to consider the thermal problem in the frequency domain instead of in the time domain as usual. Thereby, a plurality of established methods from the field of linear network theory, i.e., electrical engineering, can be transferred to the thermal problem and can be used for solving the problem.

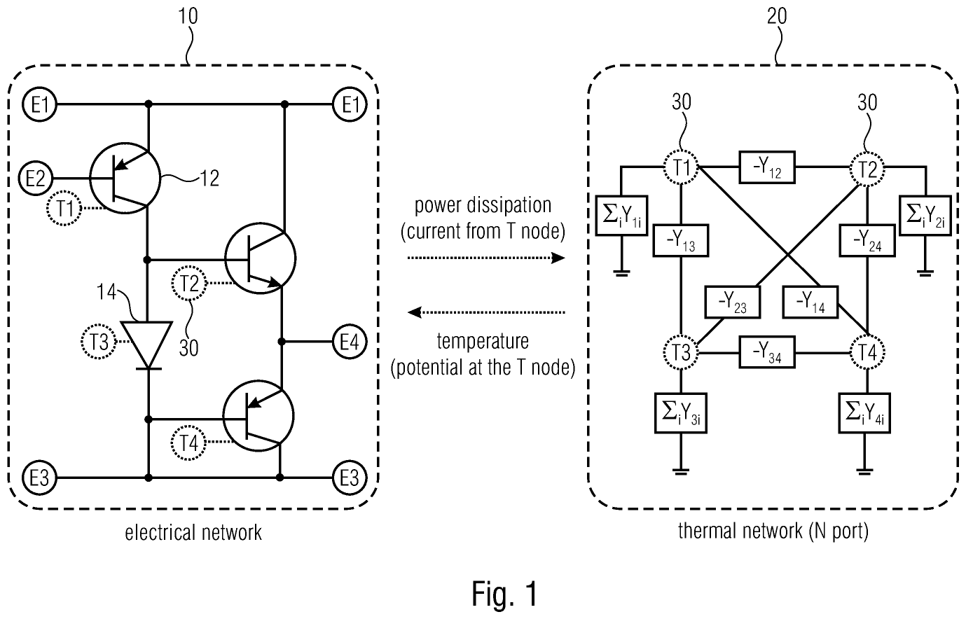

FIG. 1 illustrates an embodiment where the inventive method has the following sequence:
1. Modelling the physical structure of a circuit 10 with thermally active devices, such as transistors 12, diodes 14, etc., comprising a respective power dissipation as shown exemplarily in FIG. 1, including the silicon wafer as well as all thermal boundary conditions in a thermal simulation (in a thermal simulation program);
2. Selection of the ports 30, i.e., inputs and outputs for the thermal equivalent network to be generated;
3. Determining a thermal admittance matrix Y(f) by using the thermal simulation program for different frequencies f;
4. Reduction of the non-zero elements of the admittance matrix Y(f) by using linear dependencies within the matrix; and
5. Generating a linear thermal equivalent circuit 20 of the admittance matrices Y(f), e.g., by a method described in reference [11].

For generating the thermal admittance matrix Y(f), the following black box method can be used by using the thermal simulation (the thermal simulation program):
1. Providing a temperature oscillating at a frequency f at a port 30;
2. Providing a constant temperature at all other ports 30;
3. Resulting (normalized) heat flows at all ports result in a column of the thermal admittance matrix Y(f)
4. Determining all columns of the thermal admittance matrix Y(f) by repeated execution for remaining ports (30)

In a further embodiment, the admittance matrix Y(f) can alternatively be obtained from an impedance matrix Z(f). For this, the following method can be used:
1. Providing a heat flow oscillating at a frequency f at a port 30, wherein 0 is applied to all other ports;
2. Resulting (normalized) temperatures at all ports 30 result in a column of the thermal impedance matrix Z(f)
3. Determining all columns of the thermal impedance matrix Z(f) by repeated execution for remaining ports;
4. Determining the admittance matrix by matrix inversion Y(f)=Z(f)⁻¹

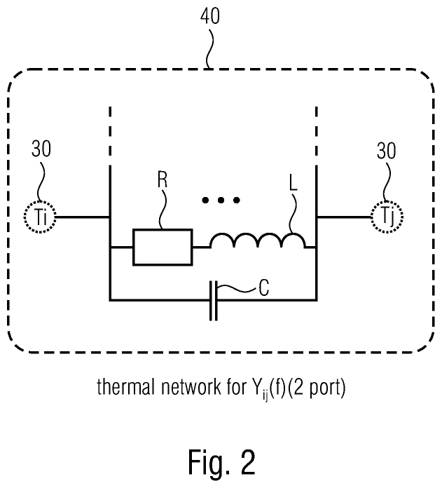

FIG. 2 shows a schematic illustration of a partial area of the physical structure of FIG. 1. Exemplarily, this thermal partial network of the thermal equivalent circuit comprises, between ports Ti and Tj, among others, an electric resistor R connected in series with a coil L and connected in parallel with a capacitor C, etc.

The explained method for generating a thermal equivalent circuit offers the following advantages with respect to known solutions:
Preventing complicated parameter dependent mathematical methods of model order reduction, so-called MOR methods;
Instead, using a simple simulation based black box method;
Knowing the mathematical equation system is not needed for this;
Linearity of the problem is not immediately needed.

The described solution allows implementation within commercial software, which enables easy to use electrothermal analysis in the development of electronics.

The effect of the above stated method is that coupling between the electrical power dissipation of the devices and the resulting self-heating in the electrical circuit can be described. Thereby, on the one hand, temperature increase due to electrical losses at any location in the electrical circuit can be predicted. On the other hand, the change of electrical characteristics of the circuit caused by the temperature increase can be determined. The resulting advantage is that disadvantageous electrothermal coupling effects can be identified and prevented already when developing the physical circuit, which results in a more reliable circuit structure.

A significant advantage is that the suggested solution can be applied in an automated manner also to practically relevant problematic quantities. Thereby, thermal equivalent networks can be broadly used in the development of electronics, which contributes to an improvement of robustness and reliability of electronic products.

The above stated methods can be used in the development of electronics to examine the effects of electrothermal interactions on the circuit behavior, for example for power management ICs (PMICs) or RF power amplifiers. Thereby, effects like the already mentioned thermal runaway can already be prevented in the design. Thereby, the electrical circuit becomes more secure and more reliable for the usage in the field. Above that, the method can also be applied to more general thermal problems having thermal sources and sinks.

Although specific combinations of features are stated in the claims and/or disclosed in the description, it is not intended that these features limit the disclosure of possible implementations. Additionally, many of these features can be combined in manners that are not specifically stated in the claims and/or disclosed in the description. Although each of the dependent claims stated below may only depend directly on one or some claims, the disclosure of possible implementations includes each dependent claim in combination with all other claims in the set of claims.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

An inventively encoded signal, such as an audio signal or video signal or transport current signal, can be stored on a digital memory medium or can be transferred on a transfer medium, such as a wireless transfer medium or a wired transfer medium, such as the Internet.

The inventive encoded audio signal can be stored on a digital memory medium or can be transferred on a transfer medium, such as a wireless transfer medium or a wired transfer medium, such as the Internet.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier. In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The apparatuses described herein may be implemented, for example, by using a hardware apparatus or by using a computer or by using a combination of a hardware apparatus and a computer.

The apparatuses described herein or any components of the apparatuses described herein may be implemented at least partly in hardware and/or software (computer program).

The methods described herein may be implemented, for example, by using a hardware apparatus or by using a computer or by using a combination of a hardware apparatus and a computer.

The methods described herein or any components of the methods described herein may be performed at least partly by hardware and/or by software (computer program).

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Fukahori, Kiyoshi, and Paul R. Gray. “Computer simulation of integrated circuits in the presence of electro thermal interaction.” IEEE Journal of Solid-State Circuits 11.6 (1976): 834-846.
[2] Digele, Georg, Steffi Lindenkreuz, and Erich Kasper. “Fully coupled dynamic electro-thermal simulation.” IEEE Transactions on Very Large Scale Integration (VLSI) Systems 5.3 (1997): 250-257.
[3] S. Wunsche, C. Clauss, P. Schwarz and F. Winkler, “Electro-thermal circuit simulation using simulator coupling,” in IEEE Transactions on Very Large Scale Integration (VLSI) Systems, vol. 5, no. 3, pp. 277-282, Sep. 1997.
[4] P. Wilkerson, A. Raman and M. Turowski, “Fast, automated thermal simulation of three-dimensional integrated circuits,” The Ninth Intersociety Conference on Thermal and Thermomechanical Phenomena In Electronic Systems (IEEE Cat. No. 04CH37543), Las Vegas, Nev., USA, 2004, pp. 706-713 Vol. 1.
[5] T. Casper, H. De Gersem and S. Schops, “Automatic generation of equivalent electro thermal SPICE netlists from 3D electro thermal field models,” 2016 17th International Conference on Thermal, Mechanical and Multi-Physics Simulation and Experiments in Microelectronics and Microsystems (EuroSimE), Montpellier, 2016, pp. 1-8.
[6] “Chip-scale electro thermal analysis”, U.S. Pat. No. 9,740,804B2, URL: https://patents.google.com/patent/U.S. Pat. No. 9,740,804B2
[7] “Post-layout thermal-aware integrated circuit performance modeling”, U.S. Pat. No. 9,721,059BI, URL: https://patents.google.com/patent/U.S. Pat. No. 9,721,059
[8] M. Salleras et al., “Comparison of model order reduction methodologies for thermal problems,” EuroSimE 2005. Proceedings of the 6th International Conference on Thermal, Mechanical and Multi-Physics Simulation and Experiments in Micro-Electronics and Micro-Systems, 2005., Berlin, Germany, 2005, pp. 60-65.
[9] Ting-Yuan Wang and Charlie Chung-Ping Chen, “SPICE-compatible thermal simulation with lumped circuit modeling for thermal reliability analysis based on modeling order reduction,” International Symposium on Signals, Circuits and Systems. Proceedings, S C S 2003. (Cat. No. 03EX720), San Jose, Calif., USA, 2004, pp. 357-362.
[10] Feng, L., Yue, Y., Banagaaya, N. et al., “Parametric modeling and model order reduction for (electro-) thermal analysis of nanoelectronic structures”, J.Math.Industry (2016) 6: 10.
[11] Gustaysen, Bjϕrn. “Computer code for rational approximation of frequency dependent admittance matrices.” IEEE Transactions on Power Delivery 17.4 (2002): 1093-1098.

1. Apparatus for generating a thermal equivalent circuit of a physical structure,
wherein the apparatus is configured to determine thermal admittance matrices based on a modelling of a physical structure for a plurality of frequencies; and
wherein the apparatus is configured to determine a thermal equivalent circuit based on the thermal admittance matrices for the plurality of frequencies.

2. Apparatus for thermal simulation of a physical structure,
wherein the apparatus for thermal simulation comprises an apparatus for generating a thermal equivalent circuit according to claim 1 and
wherein the apparatus is configured to determine a thermal response of the physical structure based on the thermal equivalent circuit and information on a thermal excitation of the physical structure.

3. Apparatus for thermal simulation according to claim 2,
wherein the apparatus is configured to simulate an electrical circuit that is part of the physical structure.

4. Apparatus for thermal simulation according to claim 2,
wherein the apparatus is configured to determine the thermal excitation in dependence on the simulation of the electrical circuit and/or
to consider the thermal response of the physical structure when simulating the electrical circuit.

5. Apparatus for thermal simulation according to claim 2,
wherein thermal equivalent circuit comprises a plurality of electrical elements.

6. Method for generating a thermal equivalent circuit of a physical structure,
wherein the method determines thermal admittance matrices based on a modelling of a physical structure for a plurality of frequencies; and
determines a thermal equivalent circuit based on the thermal admittance matrices for the plurality of frequencies.

7. Method for thermal simulation of a physical structure,
wherein the method for thermal simulation comprises a method for generating a thermal equivalent circuit of a physical structure,
wherein the method determines thermal admittance matrices based on a modelling of a physical structure for a plurality of frequencies; and
determines a thermal equivalent circuit based on the thermal admittance matrices for the plurality of frequencies, and
wherein a thermal response of the physical structure is determined by the method for thermal simulation based on the thermal equivalent circuit and information on thermal excitation of the physical structure.

8. Method for thermal simulation according to claim 7,
wherein an electrical circuit that is part of the physical structure is simulated by the method for thermal simulation.

9. Method for thermal simulation according to claim 7,
wherein the method determines the thermal excitation depending on the simulation of the electrical circuit and/or
considers the thermal response of the physical structure when simulating the electrical circuit.

10. Method for thermal simulation according to claim 7, comprising:
modelling a physical structure in a thermal simulation program,
selecting inputs and outputs as ports of a thermal equivalent network to be generated with the thermal simulation program,
determining a thermal admittance matrix Y(f) by using the thermal simulation program for different frequencies (f).

11. Method for thermal simulation according to claim 7, wherein
a linear thermal equivalent circuit is generated from the admittance matrix Y(f).

12. Method for thermal simulation according to claim 7, wherein non-zero elements of the admittance matrix Y(f) are reduced by using linear dependencies within the admittance matrix Y(f).

13. Method for thermal simulation according to claim 7, wherein the admittance matrix Y(f) is approximated with rational functions whose frequency dependent elements are acquired from calculations.

14. Method for thermal simulation according to claim 7, wherein all matrix elements of the admittance matrix Y(f) are provided simultaneously with an identical set of stable poles according to a vector matching principle.

15. Method for thermal simulation according to claim 7, wherein
a temperature oscillating at a frequency f is provided at a port
a constant temperature is provided at all other ports,
resulting (normalized) heat flows at all ports result in a column of the thermal admittance matric Y(f) and
all columns of Y(f) are determined by repeated execution for remaining ports.

16. A non-transitory digital storage medium having a computer program stored thereon to perform the method for generating a thermal equivalent circuit of a physical structure,
wherein the method determines thermal admittance matrices based on a modelling of a physical structure for a plurality of frequencies; and
determines a thermal equivalent circuit based on the thermal admittance matrices for the plurality of frequencies,
when said computer program is run by a computer.

17. A non-transitory digital storage medium having a computer program stored thereon to perform the method for thermal simulation of a physical structure,
wherein the method for thermal simulation comprises a method for generating a thermal equivalent circuit of a physical structure,
wherein the method determines thermal admittance matrices based on a modelling of a physical structure for a plurality of frequencies; and
determines a thermal equivalent circuit based on the thermal admittance matrices for the plurality of frequencies, and
wherein a thermal response of the physical structure is determined by the method for thermal simulation based on the thermal equivalent circuit and information on thermal excitation of the physical structure,
when said computer program is run by a computer.
